(19) United States
(12) Patent Application Publication
(10) Pub. No.: US 2007/0084641 A1
(43) Pub. Date: Apr. 19, 2007

(54) Method for producing and/or updating learning and/or random test samples

(75) Inventors: Thomas Bayer, Radolfzell (DE); Peter Zier, Stockach (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, Munchen (DE)

(21) Appl. No.: 10/573,403

(22) PCT Filed: Sep. 7, 2004
(86) PCT No.: PCT/EP04/09963

§ 371 Date: Mar. 27, 2006

(30) Foreign Application Priority Data
Sep. 26, 2003 (DE) 103 45 047.5

(51) Int. Cl. G01G 19/40

(52) U.S. Cl. 177/25.15

(57) ABSTRACT

The invention relates to a method for producing and/or updating learning and/or random test samples for the optimization of automatic optical readers for inscriptions on mail with adaptive classifiers, comprising the following steps: reading of wireless-readable or inscribable memory units located on or in the mail item in addition to automatic optional reading; storage of the data as destination addresses, together with the captured image of the surface of the mail item in a random test sample data base, if destination address data is identified and read from a memory unit.

The invention relates to a method for producing and/or updating learning and/or random test samples for the optimization of automatic readers for inscriptions on mail with adaptive classifiers.

For the process of postal automation, in addition to the sorting machine itself, the reading of the addresses plays a central part. A mail item can only be sorted into the correct compartment in a sorting machine when the postal address of a mailing has been determined.

The processing procedure for reading an address consists of a series of adaptive processing steps, which can be split up into image recording, locating of address blocks, segmentation of the address block into lines and words, character and/or word recognition and final adjustment with an address database.

If the address information has not been determined automatically by the reading system, or if only parts of the required information have been read, this mail item is sent to a manual processing point (video coding). Here the missing address entry/entries are inserted manually by video coding personnel.

The objective of any address reading system is therefore that of achieving very high reading rates in order to keep the manual input in video coding as low as possible. In order to achieve these high automated reading rates, a large amount of domain knowledge is necessary for adapting to the reading inscriptions that are to be read.

A large proportion of the processing steps occurring in an address reader, such as, for example, recognition of characters, words and types of script, are based on adaptive classification methods. The basic principle which all the adaptive methods have in common is learning previously collected patterns whose properties are mapped onto quantifiable feature sets. They permit conclusions to be drawn later about class membership. For this reason, adaptive methods basically have two working phases:

a) the optimization phase, composed preferably of the learning phase and test phase,

b) the can phase.

During the optimization phase, each feature set of a pattern which, depending on the task, is composed, for example, of a character, a word or an address, must have its meaning added to it in the form of the reference information so that the determination variables of the classification system can be set in an optimum way. This phase, in which the system moves towards the optimum parameter setting, preferably takes place in two steps with the basic setting of the parameters being performed in the learning phase while fine adjustment of the parameters takes place in the test phase. In the can phase, all that is then needed is the feature set of a pattern from which the classification system derives the class membership in accordance with the stored parameters.

The greatest part of the technical development work involved in achieving a classification system is incurred in the learning and test phases which can each in turn be divided into two main activities. Firstly, it is necessary to prepare a sample which satisfactorily represents the recognition task. This is followed by the actual adaptation of the classification system which, depending on the classification method and classifier design, concentrates on the optimization of the underlying determination variables such as, for example, optimization of the classifier coefficients for the polynomial classifier, optimization of the weighting factors for the neural network or selection of the most efficient reference vectors for the nearest neighbor classifier.

While the second aspect of the learning and test phases can largely take place in an automated fashion since it is generally based on well-defined mathematical methods and optimization processes, the first aspect entails a large amount of work in terms of planning, research and checking, which quite often becomes the actual sticking point of adaptive solution methodology.

In order to assemble the samples, according to the prior art large quantities of items of mail (life mail) are collected in situ and provided manually, by so-called labeling, with the reference information (meaning of the addresses, layout data). The original reference information/meaning which has been lost therefore has to be inferred from an image. (Jurgen Schurmann: Pattern Classification, Verlag [publishing house]: John Wiley & Sons, Inc., 1995, Chapter “Introduction Learning”, pp. 17-21).

The process of assembling the sample is of crucial significance for automatic recognition for a very wide variety of reasons since its quality has a direct effect on the efficiency of the subsequently adapted classification system. If the respective sample reflects the reading task under consideration sufficiently well, a good reading performance for the wide range of patterns that occur will also be forthcoming in the can phase. If too narrow a sample is selected, a good performance can also be expected in the can phase only for this restricted range and the anticipated performance will not be achieved for the rest of the patterns that occur. This aspect of the sufficiently comprehensive sample correlates directly to the concept of sample representativeness as defined in mathematical statistics.

In order to obtain a good quality and qualitatively representative sample, a series of criteria have to be fulfilled. A basic precondition for a good learning and test sample is that all the forms of a pattern class which have to be learnt are present to a sufficient degree. This is often a condition which is already difficult to fulfill since task definitions usually come from a specific application which represents only a portion of an overall recognition task. For example, in the field of font recognition within the field of mail, certain fonts, printing techniques or printing devices which represent only a limited portion of the entire range have preference at the time when a classifier is adapted. In the course of the service life of a device for reading the addresses on items of mail, other fonts and printing techniques will perhaps come to predominate and must nevertheless still be sufficiently well recognized. This aspect often varies when such techniques are used in different national areas. In a country with a high level of technology, the fonts and printing/writing devices used will be entirely different from those in a developing country. This requires the sample to be collected in as far-cited a way as possible and necessitates as wide a basis as possible for the generation of patterns.

Next, the true meaning which is assigned to a pattern must be correct. If, in fact, an adaptive system too frequently assigns the false class membership to a pattern, it will then increasingly make the wrong decision in the can phase, too, if corresponding patterns are presented. The system is simply adaptive and also learns incorrect information if this is offered to it. The lower the number of incorrect detections in the learning or test sample, the better, too, is the efficiency of the classification system that is developed.

A further aspect relates directly to the generation of the feature sets. The feature sets are usually generated using the detection algorithms which are contained in the reading software that is available since the quantities are in most cases quite considerable (for example, several thousand samples per character in the case of character recognition), and the features are supposed to approximate reality as closely as possible. However, the algorithms available are by no means without faults. Thus, for example, during character segmentation incorrect segments are created which, on the one hand, instead of containing one character, contain only fragments of characters or on the other hand, contain more than one character or even sometimes contain only interference which is not only completely irrelevant for an adaptation but is also hugely disruptive since they are seriously misleading for the classification system.

Furthermore, within a pattern recognition process, an entire series of processing steps occur which are not visibly determined and cannot be perceived visibly but rather have to be handled in a summary statistical fashion. Such steps include, for example, quantization effects as a result of binarization processes, contrast variations as a result of different colored paper backgrounds, rounding effects as a result of different resolution algorithms and scanning algorithms in scanning and printing equipment, and fluctuations in scanning and printing quality as a result of the age of and differences in the state of maintenance of the equipment.

If the automatic reader (OCR) is in the reading operation/can phase, the properties of the mail items that have been read may vary, with the result that the automatic reader is no longer working optimally. In order that it can be adapted again to the changed conditions, a new or updated random sample is now required with which the reader can be optimized, i.e. a random sample with which the reader can be optimized again has to be assembled as described above and with considerable effort involved.

The invention addresses the problem of providing a method for producing and/or updating learning and/or random test samples for optimizing automatic readers of inscriptions on items of mail using adaptive classifiers, with which method the learning and/or random test samples can be produced and/or updated automatically during the reading operation.

The problem is solved according to the invention by means of the features of claim 1, by the following steps.
reading of wireless-readable and describable memory units located on or in the mail item in addition to automatic optical reading;
if destination address information has been read and identified from a memory unit, storage of said information as destination address reference information, together with the captured image of the surface of the mail item in a random test sample database, it will be possible to generate learning and random test samples for optimizing automatic optical readers (OCRs) without any considerable manual effort being involved.

Advantageous embodiments of the invention are set out in the sub-claims.

It is thus advantageous to generate a signal for the optimization of the automatic optical reader if a certain number of automatically created entries in the random test sample database have been achieved and/or if a fixed time interval has been exceeded since the previous optimization.

It is also advantageous to configure the memory units as RFID tags, that is, if they are described and read by means of radio waves.

Since it is advantageous if the reference information in the random sample is in text form, in the case of stored address information in coded form, the address text can be determined automatically from an address dictionary comprising all the variants thereof and is entered into the random test sample database.

The invention will be described in more detail below in an exemplary embodiment, with reference to the drawings, in which:

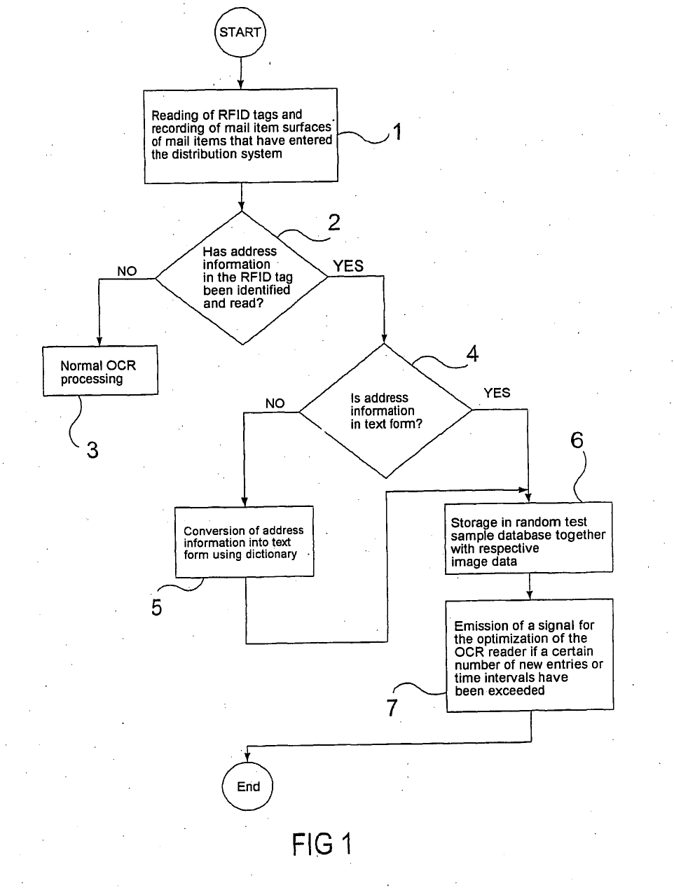

FIG. 1 is a flowchart of the process procedure.

The use of RFID tags, in particular of passive RFID tags for labelling mail items, has been known prior art (U.S. Pat. No. 3,750,167; U.S. Pat. No. 6,557,758 B1) for some time now. The tags are used to identify the mail items in a contact-free manner by means of radio waves. In addition to the identification information, the RFID tags can also contain further information, such as destination address information, for example.

When the mail items reach the distribution system (the postal service, for example), the surfaces of the mail items displaying the destination addresses are in each case recorded by means of a camera arrangement and stored so that the target address can be read into an OCR reader. At the same time there ensues the wireless reading of the RFID tag which is located in or on the relevant mail item 1. It is then established whether the RFID tag contains destination address information 2. If no destination address information has been identified and read from the RFID tag, there then ensues the normal further processing of the mail item 3, that is, OCR-reading, sorting according to sorting plans, etc. If the RFID tag does contain address information, it is established automatically whether the information is in text form or not 4.

If it is, the image data for this mail item are stored as actual data in a random test sample database together with the destination address data pertaining thereto in text form as reference data 6, with the result that the aforementioned database always contains up to date random samples. If the destination address data have been stored in the RFID tag in coded form then, with the aid of an address database, there follows conversion into the text form 5, which is then entered into the random test sample database. In the process, all the variants that are stored under the code entry in the address dictionary are then assimilated into the random test sample database. If a certain number of new entries or a certain time interval have been exceeded since the last optimization, a signal is emitted to optimize the OCR again 7. In this way, the learning and random test samples for the OCR readers are updated during the reading operation, automatically and without any manual effort being involved.

1. Method for producing and/or updating learning and/or random test samples, for the optimization of automatic optical readers for inscriptions on mail with adaptive classifiers, characterized by the following steps:
reading out of the content of wireless-readable and describable electronic memory units located on or in the mail item in addition to automatic optical reading;
if destination address information is identified and read from a memory unit, storage of said information as destination address data, together with the captured image of the surface of the mail item in a random test sample database.

2. Method according to claim 1, characterized in that a signal is created for the optimization of the automatic optical reader if a certain number of automatically created entries in the random test sample database is achieved and/or if a fixed time interval has been exceeded since the previous optimization.

3. Method according to claim 1, characterized in that the storage units are configured as RFID-tags/transponders.

4. Method according to claim 1, characterized in that when the address information is provided in coded form, the address text is automatically determined from an address dictionary comprising all the variants thereof and is entered into the random test sample database.
